(19) United States
(12) Patent Application Publication
(10) Pub. No.: US 2003/0061439 A1
(43) Pub. Date: Mar. 27, 2003

(54) Distributed executing units of logic integrated circuits connected to & executes on data in local data storage

(76) Inventor: Jeng-Jye Shau, Palo Alto, CA (US)

Correspondence Address: Bo-In Lin, 13445 Mandoli Drive, Los Altos Hills, CA, 94022, US

(21) Appl. No.: 10/254,148

(22) Filed: Sep. 25, 2002

Related U.S. Application Data
(60) Provisional application No. 60/325,060, filed on Sep. 25, 2001.

(51) Int. Cl. G06F 12/00

(52) U.S. Cl. 711/105; 711/103

(57) ABSTRACT

The present invention discloses a data handling device that includes a plurality of distributed execution units (EU) each disposed next to and connected to a local data storage unit for accessing and executing instructions on data stored in the local data storage unit. In a preferred embodiment, each of the plurality of distributed execution units (EU) further includes an arithmetic logic unit (ALU). In another preferred embodiment, each of the plurality of distributed execution units (EU) further includes a floating point unit (FPU). And, each of the plurality of distributed execution units (EU) further includes an address generation unit (AGU).

This application claims priority to pending U.S. provisional patent application entitled DISTRIBUTED EXECUTION UNITS OF LOGIC INTEGRATED CIRCUIT CONNECTED TO & EXECUTES ON DATA IN LOCAL DATA STORAGE filed Sep. 25,2001 by Jeng-Jye Shau and accorded Serial No. 60/325,060, the benefit of its filing date being hereby claimed under Title 35 of the United States Code.

### BACKGROUND OF THE INVENTION

The present invention relates to large-scale logic integrated circuit (IC) design, especially on methods to reduce complexity of data transfer circuits of large scale IC.

Before the invention itself is explained, a prior computer system is first explained to facilitate the understanding of the invention. FIG. 1 is a simplified system block diagram for a typical prior art computer system. A typical computer system is equipped with mass storage units (MSU's) such as hard disk, floppy disk, or compact disk (CD) read only memory (ROM) to store software programs and data. The system also needs input/output (I/O) devices such as key board, mouse, monitor, parallel port, series port, or networking card to communicate with the outside world. Most of the computer activities are controlled by a motherboard (103). The motherboard has many components such as a microprocessor (101), main memory, level two (L2) and level three (L3) cache memories, and a board level BUS interface. The main memory, L3 cache, and the microprocessor communicate with a board level bus (109). The L2 cache typically has its own backside bus (107) communication with the microprocessor. The microprocessor (101) is often called “central processing unit” (CPU). At the center of the CPU are a number of execution units (EU) that execute computer instructions. Examples for execution units are arithmetic logic units (ALU), floating point units (FPU), and address generation units (AGU). These EU follow instructions provided by the instruction decoder, and operate on data provided from register files. Instructions and the data are provided by the MSU's or I/O devices. Current art ALU can operate at 4 GHZ (billion cycles per seconds), while a hard disk access time is around 10 milliseconds. Since MSU's and I/O devices are by far slower than the execution units, the only way to reach high performance is to keep copies of instructions and data close to the execution units. That is why we need to have local caches, level 1 (L1) cache, and a complex memory hierarchy in the computer system.

FIG. 2(a) is a float chart showing the procedures for a memory access of a typical computer system such as the example in FIG. 1. When the execution units need instructions or data, the system must execute memory access to get the information. The basic concept is to look for the needed information from the nearest memory device. If the information can be found in local cache, the results are sent to register files or instruction decoders directly, followed by some book keeping activities such as updating flags and updating higher level storage devices. If the information is not stored in local cache, we need to look into L1 cache. If the information can be found in L1 cache, the results are sent to register files or instruction decoders directly, followed by some book keeping activities such as updating flags and updating higher level storage devices. A copy of the information, including nearby data, are also stored into local cache so that future memory access is likely to hit local cache. If the information is not stored in L1 cache, we need to look into L2 cache. If the information can be found in L2 cache, the results are sent to register files or instruction decoders directly, followed by some book keeping activities such as updating flags and updating higher level storage devices. A copy of the information, including nearby data, are also stored into local cache and L1 cache so that future memory access is likely to hit lower level caches. If the information is not stored in L2 cache, we need to look into L3 cache. If the information can be found in L3 cache, the results are sent to register files or instruction decoders directly, followed by some book keeping activities such as updating flags and updating higher level storage devices. A copy of the information, including nearby data, are also stored into lower level caches so that future memory access is likely to hit lower level caches. If the information is not stored in L3 cache, we need to look into main memory. If the information can be found in main memory, the results are sent to register files or instruction decoders directly, followed by some book keeping activities such as updating flags and updating higher level storage devices. A copy of the information, including nearby data, are also stored into lower level caches so that future memory access is likely to hit lower level caches. If the information is not stored in main memory, we need to get the information for MSU or I/O devices. The results are sent to register files or instruction decoders directly, followed by some book keeping activities such as updating flags. A copy of the information, including nearby data, are also stored into all the memory devices so that we can avoid these slow devices as much as possible in the future. The way for a current art cache memory to determine whether a copy of data is stored in a particular cache memory is to store the addresses of all its data into a lookup table called “TAG memory”. This TAG memory also stores book keeping parameters based on memory coherent requirements. The content of the TAG is compared with the address of a new memory access in order to determine whether the data is already stored in the cache. The look up procedures into different levels of TAG memory is the most notorious bottleneck limiting the performance of current art computer system.

Most of time, computer programs tend to loop around small sections of instructions repeatedly (called “principle of locality”). Therefore, most of time the information needed by execution units can be provided by low level caches. Low level caches can operate at pretty high speed. For example, a current art local cache can have access time around 1 nanosecond. The access time for L1 cache is typically a few nanoseconds. The speed of the storage device gets worse as we go to higher level devices, but we don't need to use them very often due to the principle of locality. This method of saving small copies of data at high speed high cost devices while keeping bigger copies of data at lower speed lower cost devices allows current art computer systems to have high performance at reasonable cost. However, the data transfer mechanism becomes extremely complex. When there are so many copies of the same data stored at various places simultaneously, we need complex control logic to assure data coherence. Each storage device has its own interface, operates at its own speed, while following its own interface protocols; transferring data efficiently between them require highly sophisticate control circuits. That is the major reason why current art microprocessors are so complex; they can have more than 100 million transistors. FIG. 2(b) shows an example of a CPU floor plan. Typically, 40-60% of the chip areas would be occupied by memory devices (221) used as caches or buffers. 60-40% of the areas are occupied by the logic circuits and data paths (223) used to control data transfer from the memory devices to execution units (225). The areas occupied by execution units (225) are typically negligible. On the other word, the performance, power consumption, and cost of current art integrated circuits are typically determined by how you store and transfer data. The designs of the execution units are relatively unimportant.

Even with the support of high cost local cache memory. The speed of execution units are still by far faster than the speed of the local cache memory. Therefore, microprocessor designers are forced to use many pipeline stages to improve overall performance. A current art microprocessor can have 12 pipeline stages to finish one instruction. This method allow current art microprocessor to operate at very high peak performance when everything flow through the pipeline smoothly. However, whenever there is any interrupts such as a unpredicted branch operation, we need to cast away everything in the pipeline, resulting tremendous waste in power. Power consumption is therefore becoming a major problem for current art microprocessors.

At the early history of IC design, the execution units were the dominating circuits in a CPU. All the other “supporting circuits” bring in needed information to support the operations of the execution units. That thinking no longer matches the reality of current IC designs. It is those supporting circuits that are dominating the area and performance. However, current art architectures still center around the historical thinking. We are using extremely complex data transfer systems to bring information to serve a few execution units. The computer architectures developed based on the out-of-date historical thinking caused performance bottlenecks and created extremely complex control logic circuits. It is time to develop novel architectures optimized for current art IC manufacture realities.

### SUMMARY OF THE INVENTION

The primary objective of this invention is to simplify the data transfer methods of logic integrated circuits. Another objective is to improve performance and reduce power consumption of logic integrated circuits by simplifying the pipeline structures. One objective of the present invention is to remove TAG lookup for most of operations in order to remove the most common speed bottleneck. The other primary objective of the present invention is to simply the system design of computer systems.

These and other objectives of the present invention are achieved by making many copies of instruction units, instead of making many copies of data. It is therefore much more likely to bring data and instructions close to execution units without complex data transfer systems. The resulting architecture has a data transfer method nearly as simple as conventional memory. Providing significant simplification in design and improvements in area, power, and performance.

While the novel features of the invention are set forth with particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a block diagram for a prior art computer system;

FIG. 2(a) is a float chart for prior art memory access procedures;

FIG. 2(b) shows the floor plan for one example of a prior art microprocessor;

FIGS. 3(a-g) illustrates the structures for execution blocks of the present invention;

FIG. 4(a) is an example for the second level execution block of the present invention;

FIG. 4(b) is a symbolic diagram illustrating multiple level execution blocks of the present invention;

FIG. 5(a) is a float chart showing the procedures to execute instructions in a prior art computer system;

FIG. 5(b) is a float chart showing the procedures for a computer system of the present invention to execute the same instructions in FIG. 5(a);

FIG. 5(c) is a float chart showing the memory access procedures of the present invention;

FIG. 6(a) shows the float chart for a prior art function call;

FIG. 6(b) is a float chart for function call procedures of the present invention; and

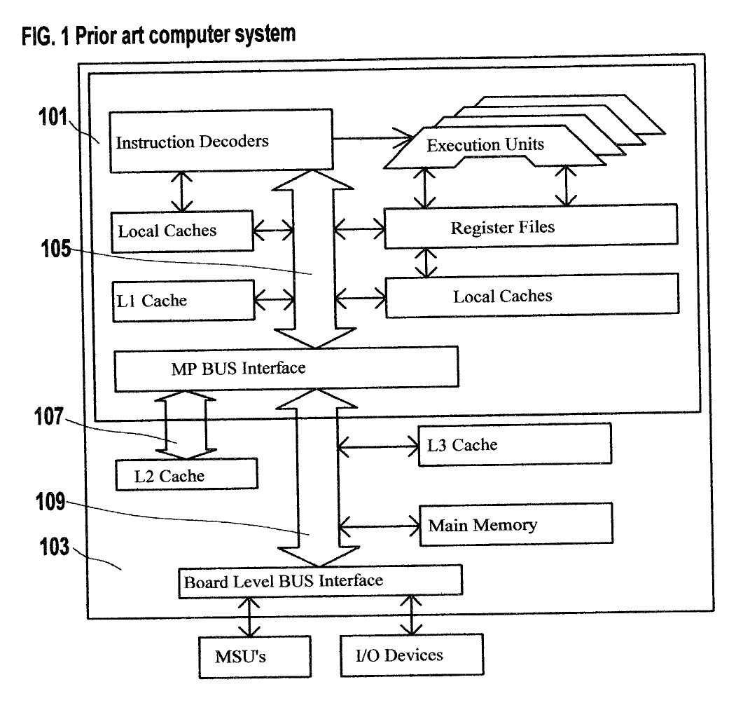

### DETAILED DESCRIPTION OF THE INVENTION

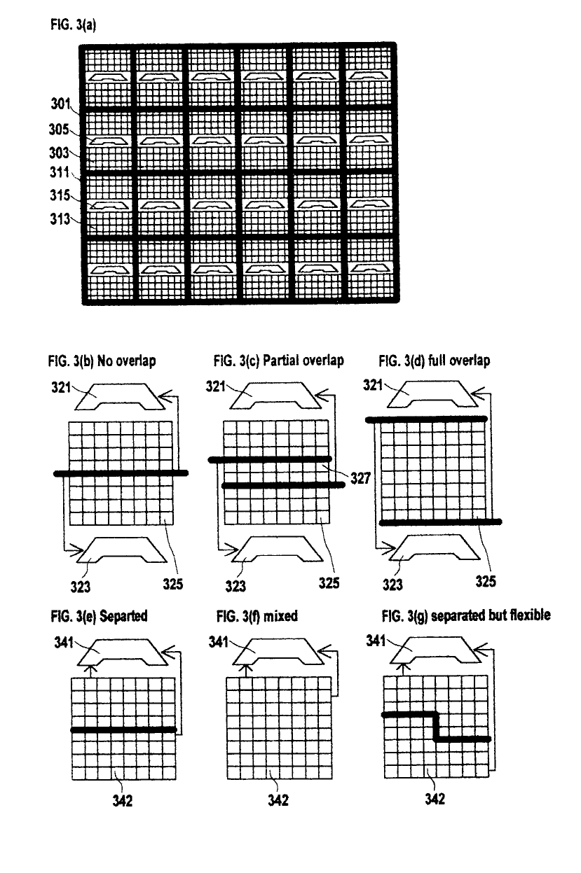

Prior art computer systems bring information close to execution units by making multiple copies of data in different levels of memory devices, and rely on the principle of locality to achieve reasonable efficiency. A microprocessor (MP) of the present invention uses many copies of execution units distributed among local memory devices as shown in the example in FIG. 3(a). This MP comprises many execution blocks (301, 311) forming an execution network. These execution blocks (EB) can have different functions and different sizes. Each execution block (301, 311) comprises local storage units (303, 313) and local execution units (305, 315). A local execution unit (305, 315) can have any type of EU such as ALU, FPU, AGU, or a combination of them. It can equip with many supporting circuits such as register files, instruction decoders, instruction pointer, . . . etc. At the most complex cases, a local execution unit can be as complex as a small prior art microprocessor. At the simplest case, the local execution can be a simple EU logic ciruit with minimum supporting devices. The local storage unit (303, 313) can be any kind of storage devices such as register files, SRAM, DRAM, ROM, EPROM, or a combination of different storage devices. The key point is to keep the local execution units (305, 315) very close to its associated local storage units (303, 313) so that the data transfer mechanism between them can be as simple as possible. Such simple relationship allow simple operation control. There is no need to have 12 stages of pipelines. 2-4 stage pipeline structures are usually enough. It is even possible to have single stage operation for many cases. The local storage units and the local execution units in different execution blocks can be connected through data transfer networks (not shown for simplicity) in a way very similar to prior art multiple level memory devices. Instructions and data are installed into the storage blocks (303, 313) for operation. At operation time, the execution unit closest to the instruction and data are used to support the operation. For example, if the instruction and data are stored in the first local storage unit (303), the EU (305) in the same EB (301) is used to execute the operation. If the operation moves to instructions stored in another local storage unit (313), the operation will be executed by the EU (315) in the new EB (311). Instead of shipping data and instructions to a few global EU like prior art microprocessors, an MP of the present invention uses many EU distributed near storage devices so that we can select an EU close to the instructions and data to execute desired operations. Since there is no need to use complex data transfer mechanism, the total area will be smaller while the overall performance can be much higher than prior systems.

The demarcation boundary of nearby EB is not necessary at fixed location. FIGS. 3(b-d) show cases when the EU (321, 323) in nearby EB are using storage units (325) between them. FIG. 3(b) shows a case when there is a fixed demarcation; the top EU (321) uses the top half of the storage unit (325), while the bottom EU (323) uses the bottom half. FIG. 3(c) shows a case when nearby EB can have partially overlapped regions. Both the top EU (321) and the bottom EU (323) can be used to support instructions stored in the overlapped region (327). FIG. 3(d) shows a case when the storage unit (325) is fully supported by both EU (321, 323). It is also possible that one storage unit (325) can be supported by EU in more than two EB. Practical EB of the present invention typically have overlapped regions (327) because it will allow us to transfer control from one EB to a nearby EB with minimum data transfer activities. It is also possible to execute the same operation in more than one EU in different EB simultaneously providing the chance to further minimize the control transfer procedures.

Ideally, an EU can obtain both instruction and data from local storage block in the same EB. Sometimes, it is not possible. We may need to obtain data and/or instructions from another EB or even from external devices. For a operation needs instruction and data stored in different EB, we can (1) select the EB closest to the instruction, (2) select the EB closest to the data, (3) select an EB somewhere in between, or (4) execute the same operation at more than one locations. It is desirable to have both instruction and associated data stored in the same EB for optimum speed. That means the storage unit (342) near an EU (341) need to store both instructions and data as close to the EU as possible. We can have separated storage devices to store instructions and data separated as illustrated in FIG. 3(e). We also can mix instructions and data into the storage unit (342) as shown in FIG. 3(f). Another possibility is to store instructions and data at separated areas in the storage unit (342) but the demarcation of instructions and data can be flexible as illustrated in FIG. 3(g).

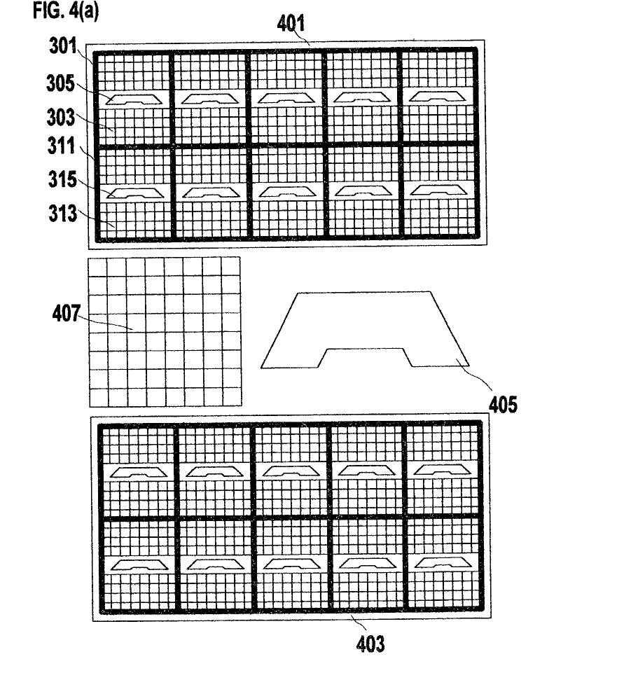

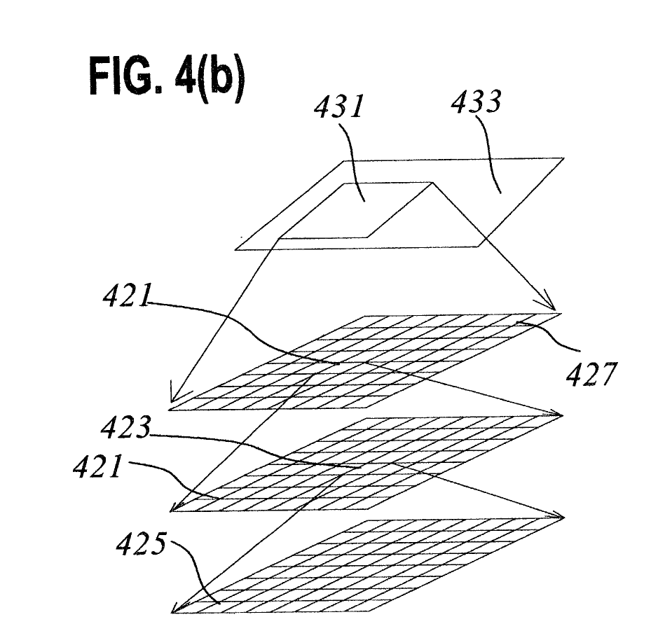

For most of cases, it is desirable to have more than one level of execution blocks. FIG. 4(a) shows the structures for a two-level execution block. In this example, there are two groups of first level execution blocks (L1EB) (401, 403). A second level execution unit (L2EU) (405) having a second level storage unit (L2SU) (407) communicates with those L1EB (301, 311), and execution operations that are more suitable for the second level execution block (L2EB). Similarly, we can have multiple levels of execution blocks. FIG. 4(b) is a symbolic diagram for a multiple level execution unit of the present invention. The microprocessor (433) comprises an execution group (431) that has three-level execution blocks. The third level execution block (L3EB) (427) comprises a network of L2EB (421) that comprises a network of L1EB (423). The data transfer methods of such multiple level execution block (M1EB) is similar to the data transfer methods of a multiple memory device.

While specific embodiments of the invention have been illustrated and described herein, it is realized that other modifications and changes will occur to those skilled in the art. For example, we can configure L3EB in the same way as a prior art MP while using EB of the present invention at lower levels. In this way, the resulting MP can be fully compatible with existing computer hardware and software. It is also possible to arrange EB in two dimensional networks so that there are multiple ways to transfer a task from one EB to another EB. The above architecture can be implement into the same IC chip, but it also can be implemented by a combination of multiple IC chips. The repeating structures of the present invention make it ideal for multiple IC implementation due to the simplicity in the interface structures.

To achieve optimum performance, the procedures provide instructions and data to an EU maybe different between prior art systems and a computer system equipped with a microprocessor of the present invention. Before the installation procedures of the present invention are explained, prior art installation methods are first described in further details to facilitate the understanding of the invention.

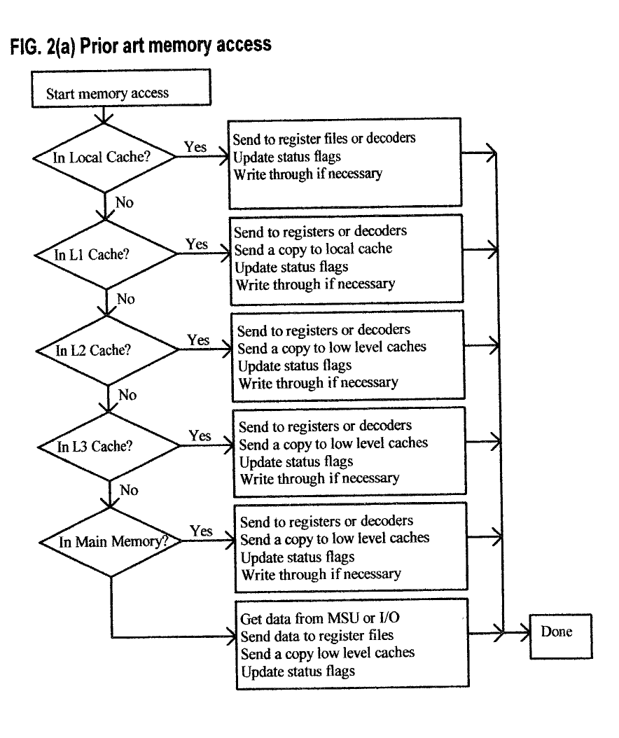

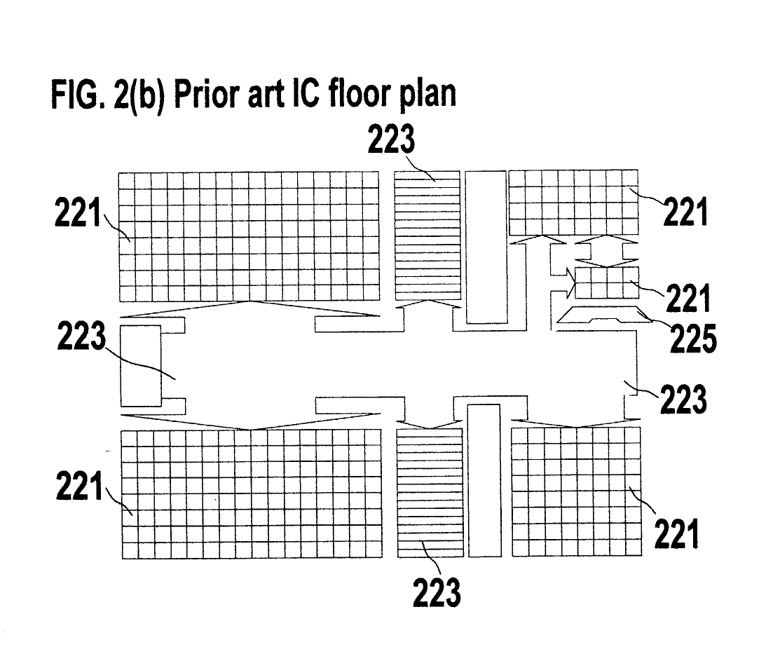

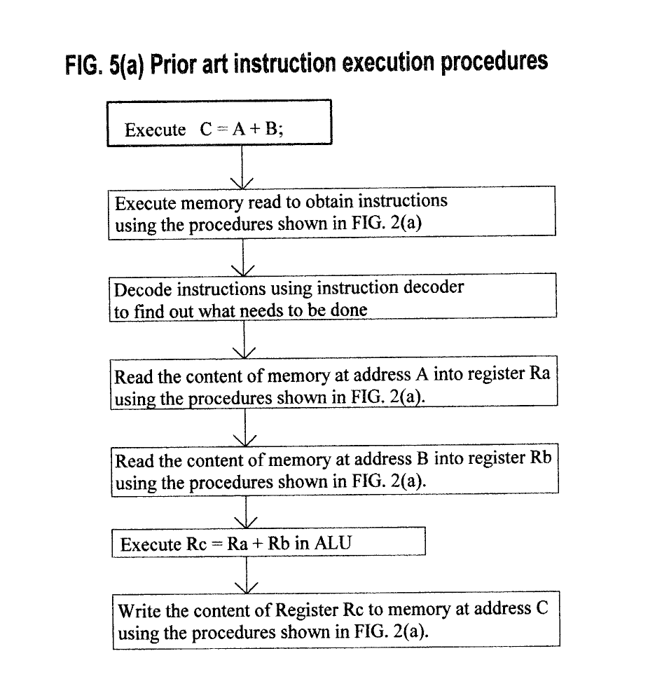

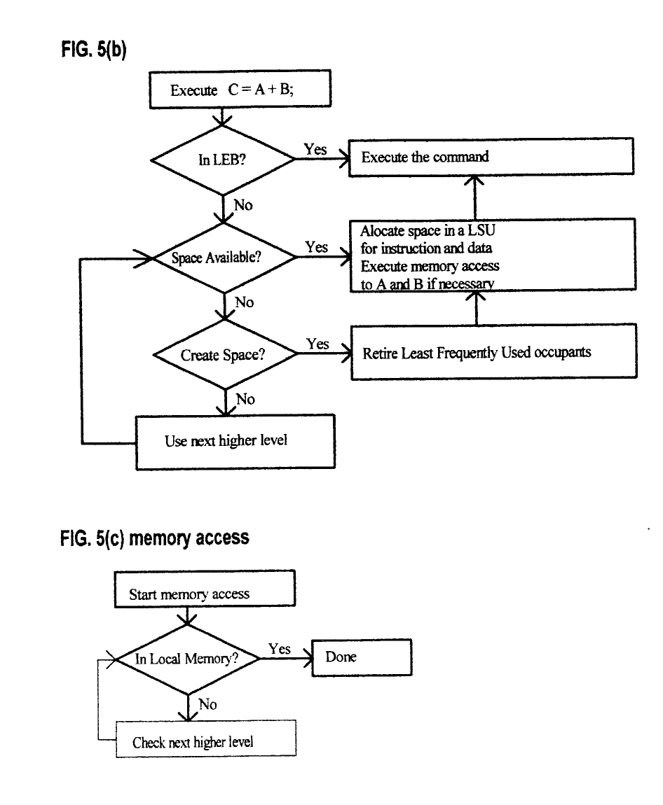

FIG. 5(a) is a float chart showing the procedures for a prior art computer system to execute a simple operation (C=A+B) where A, B, C are local variables used in part of a computer software. First, the system need to do a memory read operation to obtain the instructions using the procedures described in FIG. 2(a). If the instruction can be found in a low level cache, this memory read operation can take just a few clock cycles. If we need to obtain the instructions from a high level cache or a MSU, this operation can take a long time. At the worst case when we need to read the instructions from a MSU, we need millions of clock cycles, and we need to make room to store copies of the instructions in multiple memory devices. After the microprocessor obtained the instructions, an instruction decoder will decode them, and determine what needs to be done. The system needs to do a memory read operation to put the value of A into a register Ra, using the procedures described in FIG. 2(a). If a copy of A can be found in a low level cache, this memory read operation can take just a few clock cycles. If we need to obtain A from an MSU, this operation can take millions of clock cycles, and we need to make room to store copies of A in multiple memory devices. The next step is to do a memory read operation to put the value of B into a register Rb, using the procedures described in FIG. 2(a). After the values for both A and B have been stored into registers, an ALU can execute the “ADD” operation, and place the result into a register Rc. Finally, we can put the value of Rc into memory location C through the procedures described in FIG. 2(a). This memory write operation will trigger a series of status update procedures because we need to assure the data coherence for different copies of C at different levels of memory devices. The simple operation (C=A+B) is actually a series of complex data transfer operations for a prior art computer system.

FIG. 5(b) is a float chart showing the procedures for a computer of the present invention to execute the same operation (C=A+B). The first step is to check if the instruction and data have been installed in a local execution block (LEB), if so, we can simply go ahead and finish the job. If the instruction and data are not in a LEB yet, we need to check if space is available in an LEB. If so, the system will allocate space in a local storage unit (LSU) to store the data and instruction. If there is no space available, we need to create space by kicking allocated instructions out of the system to open room for these new operations. If we need to use high level execution blocks, we move to next high level. Memory access operations and instruction decoding maybe necessary for this step. After the allocation procedures have been finished, we can finish the operation. These installation procedures are by far less complex than prior art computer systems because most of time the procedures are executed within local devices even when the instruction has never been executed before. Seldom do we need to execute lengthy operations to high level devices. We also do not need to make multiple copies of the same data. If a local variable can be allocated in an EB, we do not need to use high level storage devices to store the same data. Since the instruction and data have been allocated in an LEB, the execution speed will be very fast for the next time when we need to execute the same operation. We also can eliminate TAG lookup using a status bit called “local bit” (LB) of the present invention. For each instruction that needs data access, we store one or a few local bits to indicate whether the needed data are stored in the same EB or not. The instruction can be executed directly when the local bits indicated all the data are in the same EB. Only for the exception cases when we are forced to store the data out of EB, lookup to higher level storage devices are executed.

To achieve optimum performance, the procedures to execute a functional call (or subroutine call) can be different between prior art systems and a computer system equipped with a microprocessor of the present invention. Before the function call procedures of the present invention are explained, prior art procedures are first described in further details to facilitate the understanding of the invention.

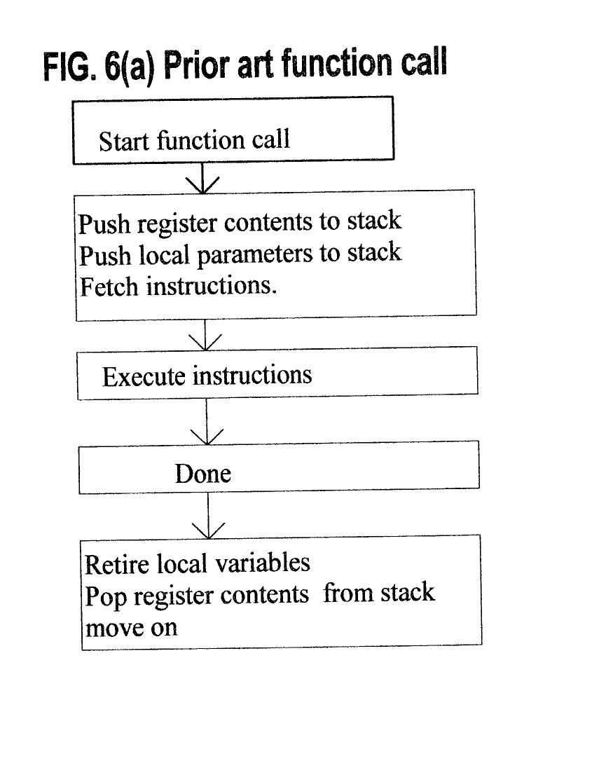

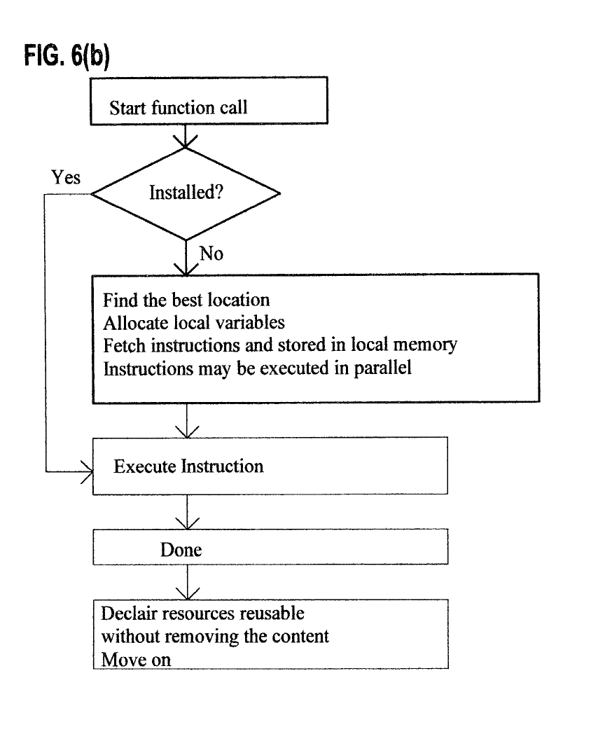

FIG. 6(a) is a flow chart for the prior art function call procedures. After a function call is started, the system need to push current register contents, flag values, and other status related parameters into a stack. The stack is usually implemented as a reserved memory block in the main memory, and there are copies of the stack stored into various levels of cache memories. All the local variables required by the function are also pushed to the stack, then we start to fetch instructions in the function following the memory access procedures described in FIG. 2(a). The instructions in the function are executed one by one following the same prior art procedures described in previous sections. Other function calls may happen during this function call. After everything is done, local variables are retired from the stack, so does the register contents and flag bits belongs to the procedure that make this current functional call. A large number of memory operations are required for such prior art function call operation.

FIG. 6(b) is a flow chart showing one example for the function call procedures of the present invention. After a function call is started, the system first check if the function has been allocated. It the same function has been allocated before, we know all the instructions and all the required local variables are already allocated into EB of the present invention. We simply jump into the right position and finish the jobs. If this is the first time the function is called, or if the previous allocation has been kicked out of the system, we will start the function allocation procedure using the procedures described in previous sections. We will find the best location to install the function, find space in local memory devices for the local variables needed for the function, the instructions are also fetched and stored in local memory devices. All the instructions are actually executed in the same time as the allocation procedures. After the function call is done, all the resources used by the functional call are declared available for other procedures, but they are not removed from the system because it is highly possible the function will be used very soon. Then we move onto other operations. Prior art function call always need to re-do the stack operations and the instruction fetch operations every time the function is called. For a system of the present invention, most of time we will find all the resource needed for a function call is already ready for operation. Thousands of clock cycles can be saved to improve both performance and power consumption dramatically. Another major difference is in the resource occupied by the local variable in the function. A local variable is a memory storage space needed only in the function. For a prior art functional call, local variables of a function are pushed into stack memory, which creates multiple copies in multiple memory devices. For a system of the present invention, besides rare exceptions (for the case when the size of local variable is larger than the size of local memory device), local variables occupy space in local memory device and nowhere else. The resource utilization is therefore by far more efficient.

While specific embodiments of the invention have been illustrated and described herein, it is realized that other modifications and changes will occur to those skilled in the art. The novel elements for the instruction allocation of the present invention is to place both instruction and data close to execution units in the same EB, and there are many execution units available for such installation because we distribute many copies of execution units among local memory devices. The present invention also uses local bits to reduce the need for address lookup. A prior art system always need TAG lookup for all memory operations. The systems of the present invention don't do any address lookup unless the local bits indicate the needs to do so. The function call allocation procedures of the present invention avoid using stack for most of cases. Prior art function call will need to execute the allocation procedures every time a function is called. The present invention can bypass all the allocation procedures if the function has been allocated before. The current invention also provides method to put local variables into local hardware. It is equivalent to the case when a prior art system has huge register files.

A hardware of the present invention can have hundreds or even thousands of execution units. It is possible to execute thousands of instructions simultaneously. For a operation such as

C(i)=A(i)+B(i), where i=1, 2, 3, 4 . . . , N,

a prior art system need to repeat the operations shown in FIG. 5(a) N times in series in order to finish the operation. A system of the present invention can install the operation into N execution blocks and execute the whole formulae in a single step. We also can configure a large number of execution units of the present invention to perform AND logic operation while connecting their outputs with wired OR connections. That is equivalent to have a programmable logic array which can execute any complex logic operation in one cycle.

While specific embodiments of the invention have been illustrated and described herein, it is realized that other modifications and changes will occur to those skilled in the art. It is therefore to be understood that the appended claims are intended to cover all modifications and changes as fall within the true spirit and scope of the invention.

I claim:

1. A data handling device comprising:
a plurality of distributed execution units (EU) each disposed next to and connected to a local data storage unit for accessing and executing instructions on data stored in said local data storage unit.

2. The data-handling device of claim 1 wherein:
each of said plurality of distributed execution units (EU) further includes an arithmetic logic unit (ALU).

3. The data-handling device of claim 1 wherein:
each of said plurality of distributed execution units (EU) further includes a floating point unit (FPU).

4. The data-handling device of claim 1 wherein:
each of said plurality of distributed execution units (EU) further includes an address generation unit (AGU).

5. The data-handling device of claim 1 wherein:
said local data storage unit further comprising a plurality of dynamic random access memory (DRAM) cells.

6. The data-handling device of claim 1 wherein:
said local data storage unit further comprising a plurality of static random access memory (SRAM) cells.

7. The data-handling device of claim 1 wherein:
said local data storage unit further comprising a plurality of read only memory (ROM) cells.

8. The data-handling device of claim 1 wherein:
said local data storage unit further comprising a plurality of erasable programmable read only memory (EPROM) cells.

9. The data-handling device of claim 1 wherein:
each of said plurality of distributed execution units (EU) and said local data storage unit constituting an execution block (EB) and said data handling system comprising a plurality of execution blocks (EB).

9. The data-handling device of claim 1 wherein:
said local data storage unit disposed between a first execution unit (EU) and a second execution unit (EU) wherein said data storage unit is divided into a first data storage sub-unit to provide data for said first EU and second data storage sub-unit to provide data for said second EU.

10. The data-handling device of claim 9 wherein:
said first and second data storage sub-units of said local data storage unit are two separate data storage sub-units.

11. The data-handling device of claim 9 wherein:
said first and second data storage sub-units of said local data storage unit are two partially overlapped data storage sub-units.

12. The data-handling device of claim 9 wherein:
said first and second data storage sub-units of said local data storage unit are two completely overlapped data storage sub-units.

13. The data-handling device of claim 1 wherein:
said plurality of execution units (EU) each with said local data storage unit are distributed and interconnected over a two-dimensional (2D) configuration.

14. The data-handling device of claim 1 wherein:
said plurality of execution units (EU) each with said local data storage unit are distributed and interconnected over a three-dimensional (3D) configuration.

15. The data-handling device of claim 14 wherein:
said 3D configuration of said distributed plurality of execution units (EU) each with said local data storage unit are distributed and interconnected over a multiple-level three-dimensional (3D) configuration.

16. A microprocessor for a computer comprising:
a plurality of distributed execution units (EU) each disposed next to and connected to a local data storage unit for accessing and executing computer instructions on data stored in said local data storage unit.

17. A method for configuring a data handling device comprising:
disposing a plurality of distributed execution units (EUs) by placing each of said EUs next to and connected to a local data storage unit for accessing and executing instructions on data stored in said local data storage unit.

18. The method of claim 17 wherein:
said step of placing each of said plurality of distributed execution units (EUs) further includes a step of configuring each of said EUs to include an arithmetic logic unit (ALU).

19. The method of claim 17 wherein:
said step of placing each of said plurality of distributed execution units (EUs) further includes a step of configuring each of said EUs to include a floating point unit (FPU).

20. The method of claim 17 wherein:
said step of placing each of said plurality of distributed execution units (EUs) further includes a step of configuring each of said EUs to include an address generation unit (AGU).

21. The method of claim 17 wherein:
said step of placing each of said plurality of distributed execution units (EUs) further includes a step of configuring each of said EUs to include a plurality of dynamic random access memory (DRAM) cells.

22. The method of claim 17 wherein:
said step of placing each of said plurality of distributed execution units (EUs) further includes a step of configuring each of said EUs to include a plurality of static random access memory (SRAM) cells.

23. The method of claim 17 wherein:
said step of placing each of said plurality of distributed execution units (EUs) further includes a step of configuring each of said EUs to include a plurality of read only memory (ROM) cells.

24. The method of claim 17 wherein:
said step of placing each of said plurality of distributed execution units (EUs) further includes a step of configuring each of said EUs to include a plurality of erasable programmable read only memory (EPROM) cells.

25. The method of claim 17 wherein:
said step of disposing said plurality of distributed execution units (EUs) by placing each of said EUs next to and connected to said local data storage unit further comprising a step of configuring each of said plurality of distributed execution units (EU) and said local data storage unit as an execution block (EB) and configuring said data handling system as a plurality of execution blocks (EB).
